(19) United States
(12) Patent Application Publication
(10) Pub. No.: US 2017/0116157 A1
(43) Pub. Date: Apr. 27, 2017

(54) PARALLELIZING MATRIX FACTORIZATION ACROSS HARDWARE ACCELERATORS

(71) Applicant: International Business Machines Corporation, Armonk, NY (US)

(72) Inventors: Liana L. Fong, Irvington, NY (US); Wei Tan, Elmsford, NY (US)

(21) Appl. No.: 14/953,645

(22) Filed: Nov. 30, 2015

Related U.S. Application Data
(63) Continuation of application No. 14/920,111, filed on Oct. 22, 2015.

(51) Int. Cl. G06F 17/16

(52) U.S. Cl. CPC G06F 17/16

(57) ABSTRACT

A computer-implemented method includes receiving a rating matrix R. A matrix X is calculated in a matrix factorization of R, where R≈X·Θ^{T}. Calculating X includes selecting a first value for variable p and a second value for variable q; partitioning Θ^{T} by columns into p partitions of Θ^{T}; partitioning X by rows into q partitions of X; and partitioning R by rows and columns into p*q partitions of R. Calculating X further includes copying to each accelerator, of a plurality of accelerators, a corresponding partition of Θ^{T}, as well as a partition of R corresponding to the accelerator and to a current partition of X. Calculating X further includes calculating, by the plurality of accelerators, a plurality of partial solutions for the current partition of X, and aggregating the plurality of partial solutions into a solution for the current partition of X.

### DOMESTIC PRIORITY

This application is a continuation of U.S. patent application Ser. No. 14/920,111, filed Oct. 22, 2015, and all the benefits accruing therefrom under 35 U.S.C §119, the contents of which is herein incorporated by reference in its entirety.

### BACKGROUND

Embodiments of the present invention relate to matrix factorization and, more specifically, to parallelizing matrix factorization across hardware accelerators.

Matrix factorization, also known as matrix completion, is a powerful algorithm to derive latent features from observations. The generic form of matrix factorization is as follows: given an observation matrix R with some observed entries and some missing ones, R can be approximated by the multiplication of two dense, low-rank matrices X and Θ^{T} (i.e., the transpose of Θ) in the form of R≈X·Θ^{T}.

Matrix factorization is widely used in recommendation systems, where R is a rating matrix (i.e., a user-item matrix) recording users' ratings of items. With recommendations being pervasive in Internet applications, including e-commerce, digital content streaming, and search engine advertising, matrix factorization is considered one of the best methods for collaborative filtering. Recently, matrix factorization has also been applied in text mining to derive hidden features of words.

Given the wide application and versatility of matrix factorization, efficient implementation is important.

### SUMMARY

According to an embodiment of this disclosure, a computer-implemented method includes receiving a rating matrix R. A matrix X is calculated in a matrix factorization of R, where the calculation of X is based on a matrix Θ^{T} and where R≈X·Θ^{T}. Further, calculating the matrix X includes selecting a first value for variable p and a second value for variable q; partitioning Θ^{T} by columns into p partitions of Θ^{T}; partitioning X by rows into q partitions of X; and partitioning R by rows and columns into p*q partitions of R. Calculating the matrix X further includes copying to each accelerator, of a plurality of accelerators, a corresponding partition of Θ^{T} and a partition of R corresponding to the accelerator and corresponding to a current partition of X. Calculating the matrix X further includes calculating, by the plurality of accelerators, a plurality of partial solutions for the current partition of X, and aggregating the plurality of partial solutions into a solution for the current partition of X.

In another embodiment, a system includes a memory and one or more computer processors communicatively coupled to the memory. The one or more computer processors are configured to receive a rating matrix R. The one or more computer processors are further configured to calculate a matrix X in a matrix factorization of R, where the calculation of the matrix X is based on a matrix Θ^{T} and where R≈X·Θ^{T}. To calculate the matrix X, the one or more computer processors are further configured to select a first value for variable p and a second value for variable q; partition Θ^{T} by columns into p partitions of Θ^{T}; partition X by rows into q partitions of X; and partition R by rows and columns into p*q partitions of R. To calculate the matrix X, the one or more computer processors are further configured to copy to each accelerator, of a plurality of accelerators, a corresponding partition of Θ^{T} and a partition of R corresponding to the accelerator and corresponding to a current partition of X. To calculate the matrix X, the one or more computer processors are further configured to calculate, at the plurality of accelerators, a plurality of partial solutions for the current partition of X, and to aggregate the plurality of partial solutions into a solution for the current partition of X.

In yet another embodiment, a computer program product for matrix factorization includes a computer readable storage medium having program instructions embodied therewith. The program instructions are executable by a processor to cause the processor to perform a method. The method includes receiving a rating matrix R. Further according to the method, a matrix X is calculated in a matrix factorization of R, where the calculation of X is based on a matrix Θ^{T} and where R≈X·Θ^{T}. Calculating the matrix X includes selecting a first value for variable p and a second value for variable q; partitioning Θ^{T} by columns into p partitions of Θ^{T}; partitioning X by rows into q partitions of X; and partitioning R by rows and columns into p*q partitions of R. Calculating the matrix X further includes copying to each accelerator, of a plurality of accelerators, a corresponding partition of Θ^{T} and a partition of R corresponding to the accelerator and corresponding to a current partition of X. Calculating the matrix X further includes calculating, by the plurality of accelerators, a plurality of partial solutions for the current partition of X, and aggregating the plurality of partial solutions into a solution for the current partition of X.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a diagram of a matrix factorization system, according to some embodiments of this disclosure;

FIG. 2 is a flow diagram of method for performing matrix factorization, according to some embodiments of this disclosure;

FIG. 3 is a second diagram of the matrix factorization system, according to some embodiments of this disclosure; and

FIG. 4 is a block diagram of a computer system for implementing some or all aspects of the matrix factorization system, according to some embodiments of this disclosure.

### DETAILED DESCRIPTION

The technical challenges of matrix factorization processing lie in two primary aspects: scale and speed.

While many existing techniques target medium-sized problems, such as Netflix® movie recommendations, which involve approximately 500 thousand users, 20 thousand items, and 100 million ratings, the industry-scale recommendation problems have evolved to two orders of magnitude larger than such medium-sized problems. For example, Facebook® recommendations involve 1 billion users, millions of items, and over 100 billion ratings. No conventional system is able to efficiently handle recommendation problems at this scale.

With respect to speed, matrix factorization is used in many online applications where recommendations need to adapt promptly to changes or trends. To achieve adequate speed, some conventional techniques require big (e.g., 50-node) distributed clusters that have high management complexity, and may still result in sub-optimal performance.

There are a number of challenges in implementing large-scale matrix factorization on graphics processing units (GPUs). For instance, many matrix factorization methods based on central processing units (CPUs) use stochastic gradient descent (SGD), which splits an input rating matrix into blocks and uses sophisticated block scheduling to avoid update conflicts. Although previous work is able to parallelize the split matrix on tens of CPU cores, these techniques require substantial effort to scale to the thousands of cores on a GPU. Moreover, matrix factorization is inherently sparse and memory bound, making it difficult to utilize the computation power of GPUs. Additionally, large-scale matrix factorization on GPUs is limited by the memory and interconnection bandwidth of GPUs.

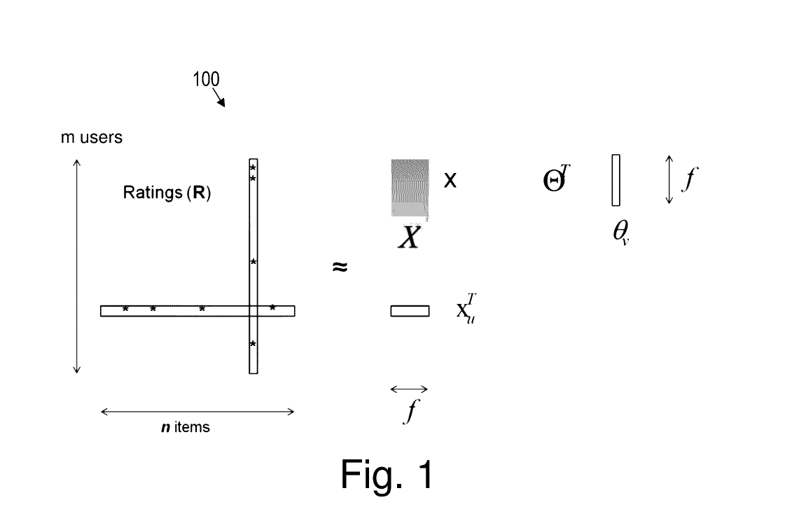

FIG. 1 is a diagram of a matrix factorization system 100, according to some embodiments of this disclosure. In some embodiments, a matrix R is a rating matrix (i.e., a user-item matrix) with each R^{(ij)} being user i's rating of item j. Matrix R may be an m-by-n matrix representing m users and n items. As shown, the matrix factorization system 100 may decompose R by matrix factorization into matrices X and Θ^{T}, where X is an m-by-f matrix and Θ^{T} is an f-by-n matrix, such that R≈X·Θ^{T}. Further, xᵤ^{T} denotes the u^{th} row of X, where xᵤ is its transpose, and θᵥ denotes the v^{th} column of Θ^{T}, where θᵥ^{T} is its transpose. One of skill in the art will understand how to utilize the resulting X and Θ^{T} to provide recommendations of items to users, based on the rating matrix R.

Some embodiments of the matrix factorization system 100 herein replace the widely used stochastic gradient descent (SGD) with the alternating least squares (ALS) algorithm. Generally, ALS is computationally more expensive than SGD but is inherently parallel, thus enabling some embodiments of the matrix factorization system 100 to exploit numerous (e.g., thousands of) GPU cores. Although this disclosure refers to the use of GPUs throughout, one of skill in the art will understand that other hardware accelerators may be used in place of GPUs. Thus, where a GPU is mentioned in this disclosure, it will be understood that some other hardware accelerator may be substituted.

Given rᵤᵥ, a non-zero element of matrix R at position (u, v), matrix factorization may seek to minimize the following cost function, with weighted-λ-regularization to avoid over-fitting, where n_{X}_{ᵤ} and n_{θ}_{ᵥ} respectively denote the total number of ratings on user u and item v:

$$J = {\sum }_{u , v} {( {r}_{uv} - {x}_{u}^{T} {θ}_{v} )}^{2} + λ ( {\sum }_{u} {n}_{{X}_{u}} \vert \vert {x}_{u} {\vert \vert}^{2} + {\sum }_{v} {n}_{{θ}_{v}} \vert \vert {θ}_{v} {\vert \vert}^{2} )$$

The matrix factorization system 100 may use the ALS approach, and may thus first determine X while fixing Θ, and then determine Θ while fixing X. Consider:

$$\frac{\partial J}{\partial {x}_{u}} = 0 ; \frac{\partial J}{\partial {θ}_{v}} = 0$$

This leads to the following equations:

$${\sum }_{{r}_{uv} \neq 0} ( {θ}_{v} {θ}_{v}^{T} + λ I ) \cdot {x}_{u} = {Θ}^{T} \cdot {R}_{u *}^{T}$$

$${\sum }_{{r}_{uv \neq 0}} ( {xx}_{u}^{T} + λ I ) \cdot {θ}_{v} = {X}^{T} \cdot {R}_{* v}$$

In some embodiments of the matrix factorization system 100, the following solution may be used to update xᵤ and θᵥ:

$${x}_{u} = {[ {\sum }_{{r}_{uv} \neq 0} ( {θ}_{v} {θ}_{v}^{T} + λ I ) ]}^{- 1} {Θ}^{T} {R}_{u *}^{T} , for u = 1 , 2 , … m$$

$${θ}_{v} = {[ {\sum }_{{r}_{uv} \neq 0} ( {x}_{u} x + λ I ) ]}^{- 1} {X}^{T} {R}_{* v} , for u = 1 , 2 , … n$$

The above pair of equations will be referred to herein as the solution equations.

By these solution equations, the matrix factorization system 100 may use the ALS algorithm to update X and Θ in an alternating manner. Empirically, ALS usually converges in 5-20 complete iterations, where each complete iteration includes both an update of X and an update of Θ.

As the variables m, n, N_{z}, and f get larger, wherein N_{z} is the number of non-zero elements in the matrix R, ALS is bounded by the memory capacity of a single GPU. Existing CPU approaches only partially address this memory capacity issue. One such technique, referred to as parallel ALS (PALS), partitions X and R by rows and solves each partition in parallel by replicating Θ^{T}. However, this model parallelism is only feasible when Θ^{T} is small. The ALS implementation of Apache Spark (SparkALS), which is another CPU approach, partitions X and R by rows and then solves each partition of X in parallel. Its improvement to PALS is that, instead of replicating Θ^{T}, SparkALS splits Θ^{T} into overlapping partitions, where each partition of Θ^{T} contains only the necessary θᵥ columns for all xᵤ in the applicable partition of X.

SparkALS has several deficiencies, however. For instance, generating a partition of Θ^{T} from a partition of X is a time-consuming graph partitioning task. Transferring each partition of Θ^{T} to a partition of X involves a good deal of network traffic, especially when N_{z} is much greater than m. Additionally, a partition of Θ^{T} may still be too big to fit into a single node, especially when N_{z} is much greater than m.

In contrast, some embodiments of the present matrix factorization system 100 improve memory access so as to improve performance of a single GPU, and further parallelize ALS in multiple GPUs to handle large data sets.

In distributed machine learning, model parallelism (e.g., parallelism in solving X and Θ in matrix factorization) partitions parameters among multiple learners where each one learns a subset of parameters, while data parallelism (e.g., parallelism in R in matrix factorization) partitions training data among multiple learners where each one learns all parameters from its partial observation. Some embodiments of the matrix factorization system 100 may combine these two schemes, which achieves good results when both the model parameters and the training data are large.

According to some embodiments, the left-hand Hermitian matrix Aᵤ and the right-hand Hermitian matrix Bᵤ are defined as follows:

$${A}_{u} = {\sum }_{{r}_{uv} \neq 0} ( {θ}_{v} {θ}_{v}^{T} + λ I ) \cdot {x}_{u}$$

$${B}_{u} = {Θ}^{T} \cdot {R}_{u *}^{T}$$

In some embodiments of the matrix factorization system 100, model parallelism provides that all Aᵤ (defined in paragraph 21) in one partition X^{(j)}, for 1≦j≦q, are computed on the same GPU. Consequently, in some embodiments, a subset of Θ^{T} is transferred from CPU memory into that particular GPU. Further, the data-parallel approach of the matrix factorization system 100 may distribute the computation of each Hermitian matrix Aᵤ among multiple GPUs. Instead of transferring all θᵥs to one GPU, the matrix factorization system 100 may calculate a local Aᵤ on each GPU using the local θᵥs and may reduce, or aggregate, local Aᵤs later, as will be described in more detail below.

Each Hermitian matrix Aᵤ may be computed as follows, in the data-parallelism form:

$${A}_{u} = {\sum }_{{r}_{uv} \neq 0} ( {θ}_{v} {θ}_{v}^{T} + λ I ) = {\sum }_{i = 1}^{p} {\sum }_{{r}_{uv} \neq 0}^{{GPU}_{i}} ( {θ}_{v} {θ}_{v}^{T} + λ I )$$

This approach is illustrated in the below algorithm for updating X based on Θ, performed by some embodiments of the matrix factorization system 100.

| 1: | Given p GPUs: GPU₁, GPU₂, . . ., GPUₚ. | |
|---|---|---|
| 2: | {Θ^{T(1)}, Θ^{T(2)}, . . ., Θ^{T(p)}} ← VerticalPartition(Θ^{T}, p) | |
| 3: | {X⁽¹⁾, X⁽²⁾, . . ., X^{(q)}} ← HorizontalPartition(x, q) | |
| 4: | {R⁽¹¹⁾, R⁽¹²⁾, . . ., R^{(pq)}} ← GridPartition(R, p, q) | |
| 5: | parfor i ← 1, p do | // parallel copy to each GPUᵢ |

| | |
|---|---|
| 6: | copy GPUᵢ ← Θ^{T(i)} |

| 7: | end parfor | |
|---|---|---|
| 8: | for j ← 1, q do | // model parallel |

| | | |
|---|---|---|
| 9: | parfor i ← 1, p do | // data parallel on GPUᵢ |

| | |
|---|---|
| 10: | copy GPUᵢ ← R^{(ij)} |
| 11: | (A^{(ij)}, B^{(ij)}) ← Get_Hermitian_X_MO(R^{(ij)}, Θ^{T(i)}) |
| 12: | Synchronize_Threads( ) |
| 13: | (A₁^{(ij)}, A₂^{(ij)}, . . ., Aₚ^{(ij)}} ← A^{(ij)} |
| 14: | (B₁^{(ij)}, B₂^{(ij)}, . . ., Bₚ^{(ij)}} ← B^{(ij)} |
| 15: | Aᵢ^{(j)} ← Σₖ₌₁^{p} Aᵢ^{(kj)} |
| 16: | Bᵢ^{(j)} ← Σₖ₌₁^{p} Bᵢ^{(kj)} |
| 17: | Xᵢ^{(j)} ← Batch_Solve(Aᵢ^{(j)}, Bᵢ^{(j)}) |

| | |
|---|---|
| 18: | end parfor |

| | |
|---|---|
| 19: | end parfor |

The above algorithm solves for X based on Θ. However, one of skill in art will understand how to adapt this algorithm to solve for Θ based on X. In some embodiments, each complete iteration of the matrix factorization system 100 may involve solving for X based on Θ, according to the above, and then solving for Θ based on X; or solving for Θ based on X, and then solving for X based on Θ. These complete iterations may be performed repeatedly until a termination condition is met. For example, the complete iterations may terminate when the values of X and Θ converge, or when a threshold number of complete iterations have been performed.

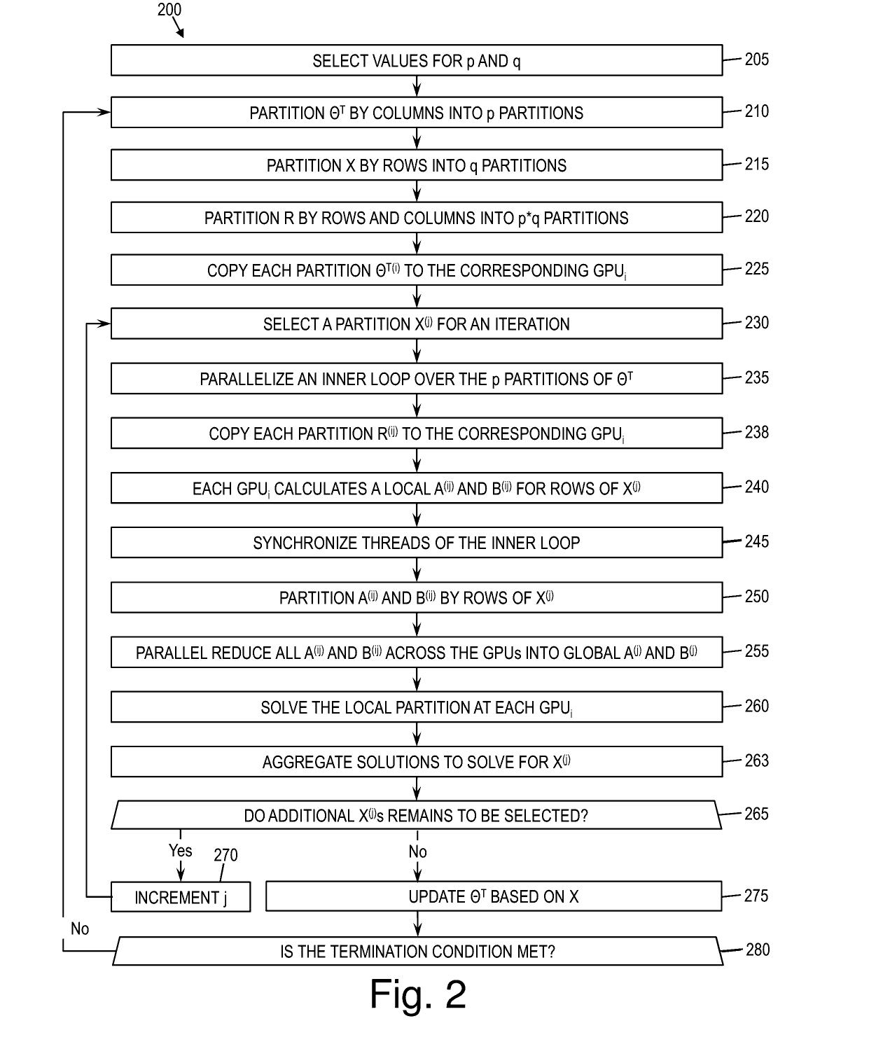

FIG. 2 is a flow diagram of method 200 for performing matrix factorization, based on the above algorithm, according to some embodiments of this disclosure.

At block 205, values of variables p and q may be selected to partition data in this method 200. Selection of these variables will be described further below.

At block 210, matrix Θ^{T} may be partitioned (i.e., split) by columns into p partitions. In some embodiments, Θ^{T} may be initialized prior to this partitioning. For example, and not by way of limitation, each element of Θ^{T} may be set to a small random number, such as a number between −0.5 and 0.5. At block 215, matrix X may be partitioned by rows into q partitions. At block 220, the rating matrix R may be partitioned by rows and columns in p*q partitions, following the partition schemes of X and Θ^{T}. Blocks 210 through 220 correspond to lines 2 through 4 of the algorithm provided above.

At block 225, each partition of Θ^{T} may be copied to a corresponding GPU. More specifically, for each i for which 1≦i≦p, the i^{th} partition of Θ^{T}, denoted by Θ^{T(i)}, may be copied to GPUᵢ. This block 225 corresponds to lines 5 through 7 of the above algorithm.

For the below blocks describing iterative loops, the iteration variables i and j are used, with both being initiated to 1. It will be understood, however, that other means of implementing iterative loops may also be used.

At block 230, the j^{th} partition of X, referred to as X^{(j)}, may be selected for an iteration of an outer loop. This outer loop may be performed for each partition of X. In some embodiments, this outer loop may be a sequential loop, rather than parallelized. In some other embodiments, however, given more GPUs than partitions of Θ^{T} (i.e., if the number of GPUs is greater than p), this outer loop may be parallelized. This selection of a partition of X for a single iteration corresponds to line 8 of the above algorithm.

At block 235, an inner loop over the p partitions of Θ^{T} may be parallelized. Multiple threads may be used, with each performing its assigned iterations. In some embodiments, p threads may be used for the parallelization, which each thread i being assigned a partition Θ^{T(i)}, and using a corresponding GPUᵢ. However, if there are an insufficient number of GPUs to enable each thread to perform an iteration on a corresponding GPU (i.e., if the number of GPUs is less than p), this inner loop may be implemented as a sequential loop, at least in part. This parallelization corresponds to line 9 of the above algorithm.

At block 238, the partitions of R corresponding to each partition of Θ^{T} may be copied to the GPU corresponding to that partition of Θ^{T}. For instance, each R^{(ij)} may be copied to the corresponding GPUᵢ. This block 238 corresponds to line 10 of the above algorithm.

At block 240, the GPU corresponding to each partition of Θ^{T} may calculate a local Aᵤ for each row of the selected partition of X. Specifically, for each row xᵤ in the selected partition of X, each GPUᵢ may calculate a local left-hand Hermitian Aᵤ based on Θ^{T(i)} and R^{(ij)}. This calculation may be performed as follows:

$${A}_{u}^{i} = {\sum }_{{r}_{uv} \neq 0}^{{GPU}_{i}} ( {θ}_{v} {θ}_{v}^{T} + λ I )$$

The GPU may further calculate a local right-hand Hermitian matrix, as follows:

Bᵤⁱ=Θ^{T(i)}·(R_{u*}^{(ij)})^{T}

The collection of each Aᵤⁱ and Bᵤⁱ on GPUᵢ are denoted herein as (A^{(ij)}, B^{(ij)}), and these calculations of block 240 correspond to line 11 of the above algorithm.

At block 245, corresponding to line 12 of the above algorithm, the various parallel threads performing the iterations of the inner loop may be synchronized. In other words, before proceeding to block 250, the matrix factorization system 100 may wait for all threads to complete the above operations.

At block 250, at each GPUᵢ, A^{(ij)} and B^{(ij)} may be partitioned (e.g., evenly) by rows of X^{(j)}. For instance, A^{(ij)} on GPUᵢ may be evenly divided into p portions A₁^{(ij)}, A₂^{(ij)}, . . . , Aₚ^{(ij)}, while B^{(ij)} may be evenly divided into B₁^{(ij)}, B₂^{(ij)}, . . . , Bₚ^{(ij)}. Block 250 corresponds to lines 13-14 of the above algorithm.

At block 255, across the p GPUs, p A^{(ij)}s and p B^{(ij)}s may be parallel reduced into global A^{(j)} and B^{(j)}. Each GPUᵢ may perform the reduction of partition i of each A^{(kj)}, for 1≦k≦p. This block 255 corresponds to lines 15-16 of the above algorithm.

At block 260, the p partitions may be solved concurrently on the p GPUs. Specifically, for instance, each GPUᵢ may solve the local partition (Aᵢ^{(j)}, Bᵢ^{(j)}) that it reduced at block 255. In other words, as described by the solution equations, a partial solve for X^{(j)} may be performed on each GPU.

At block, 263, these partial solutions may be aggregated to solve for X^{(j)}.

At decision block 265, it may be determined whether j<q, indicating that additional X^{(j)}s remain to be selected. If j<q, then at block 270, j may be incremented, and the method 200 may return to block 230.

Blocks 210 through 270 update for X based on Θ^{T}. However, as discussed above, this is only a portion of a complete iteration, which may further include updating Θ^{T} based on X. Thus, at block 275, Θ^{T} may be updated based on X. One of skill in the art will understand how to apply the above algorithm and method 200 to update Θ^{T} based on X. However, these operations are summarized as follows: partition X^{T} by columns into p partitions of X^{T}; partition Θ by rows into q partitions of Θ; partition R^{T} by rows and columns into p*q partitions of R^{T}; copy to each accelerator a corresponding partition of X^{T}; copy to each accelerator a partition of R^{T} corresponding to the accelerator and corresponding to the current partition of Θ; calculate, by the accelerators, a set of partial solutions for the current partition of Θ; and aggregate the partial solutions for the current partition of Θ into a solution for the current partition of Θ.

At decision block 280, it may be determined whether the termination condition is met. If not, then the method 200 may return to block 210 to perform another complete iteration. However, if the termination condition is met, then the method 200 may end with X and Θ^{T} having been solved for.

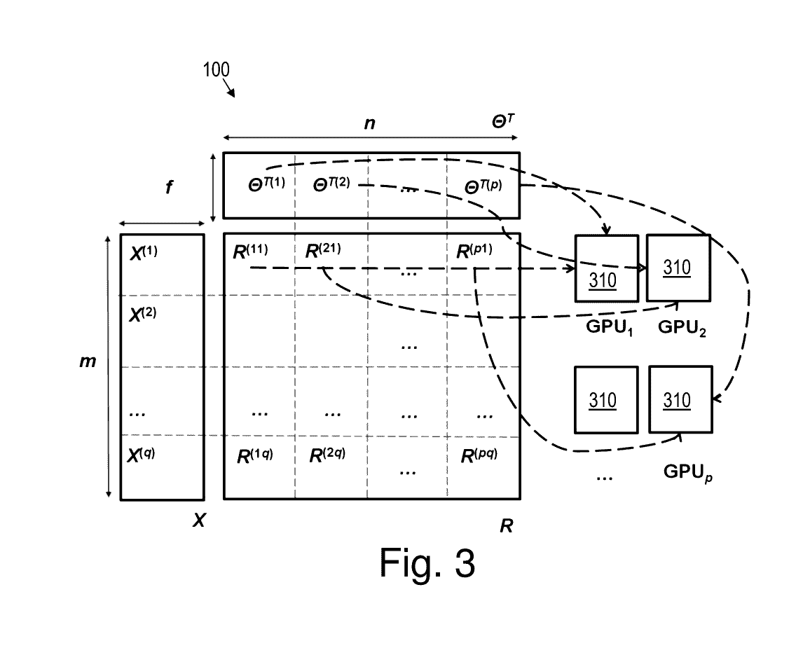

FIG. 3 is a second diagram of the matrix factorization system 100, illustrating the algorithm and method 200 described above, according to some embodiments of this disclosure. As shown, in some embodiments, Θ^{T} may be partitioned evenly and vertically and may be stored across p accelerators 310, such as GPUs. X may be partitioned evenly and horizontally and may be solved in batches, thus achieving model parallelism. Each X batch may be solved in parallel across the p accelerators 310, thus achieving data parallelism.

As illustrated above, values of the variables p and q may determine how X, Θ^{T}, and R are partitioned. Thus, prior to partitioning, the values of p and q may be selected, which may occur at block 205 of the above method 200.

According to the above description, in some embodiments, a single GPU holds X^{(j)}, Θ^{T(i)}, R^{(ij)}, A^{(j)}, and B^{(j)}. Thus, in some embodiments, the choices of p and q are subject to the following formula, where C is the memory capacity of the GPU, and where c is a headroom space being allotted for zero or more miscellaneous small variables:

$$\frac{m \times f}{q} + \frac{n \times f}{p} + \vert {R}^{( ij )} \vert + \frac{m}{q} \times {f}^{2} + \frac{m}{q} \times f + ε < C$$

For a practical example, the capacity C may be 12 GB, and E may be 500 MB.

In some embodiments, p may be selected such that

$$\frac{n \times f}{p} \approx \frac{C}{2} ,$$

and the smallest q to satisfy the above formula may be selected.

In some embodiments, p may be assigned the value of 1, in which case X may be solved on a single GPU in sequential batches. If q>1 and p=1, in some embodiments, q need not be increased any further, as there is already no need to further partition X.

In some embodiments, one or more automated or human resource managers may keep track of resource availability and cost constraints, and the matrix factorization system 100 may communicate with these resource managers for determining the values of p and q. As a result, p and q may be at least partially based on cost constraints, resource availability, or both.

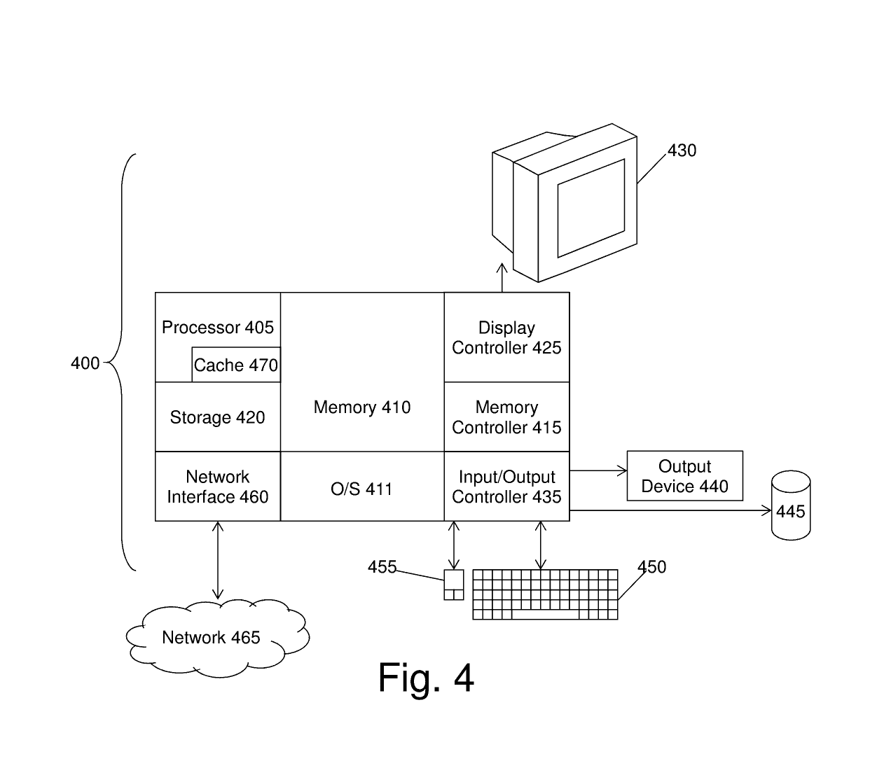

FIG. 4 illustrates a block diagram of a computer system 400 for use in implementing a matrix factorization system 100 or method 200 according to some embodiments. The matrix factorization systems 100 and methods 200 described herein may be implemented in hardware, software (e.g., firmware), or a combination thereof. In some embodiments, the methods described may be implemented, at least in part, in hardware and may be part of the microprocessor of a special or general-purpose computer system 400, such as a personal computer, workstation, minicomputer, or mainframe computer.

In some embodiments, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. Input devices such as a conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be a custom made or commercially available processor, a central processing unit (CPU), an auxiliary processor among several processors associated with the computer system 400, a semiconductor based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid state drive. The stored instructions in memory 410 or in storage 420 may include those enabling the processor to execute one or more aspects of the matrix factorization systems 100 and methods 200 of this disclosure.

The computer system 400 may further include a display controller 425 coupled to a display 430. In some embodiments, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In some embodiments, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

Matrix factorization systems 100 and methods 200 according to this disclosure may be embodied, in whole or in part, in computer program products or in computer systems 400, such as that illustrated in FIG. 4.

Technical effects and benefits of some embodiments include enabling matrix factorization to exploit numerous GPU cores. Further, some embodiments improve memory access in ALS, including reducing discontiguous memory access, retaining hotspot variables in faster memory, and aggressively using registers, so as to approach the roofline performance of a single GPU. Additionally, some embodiments combine data parallelism with model parallelism in ALS, and apply an innovative parallel reduce method to efficiently utilize multiple GPUs simultaneously.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for matrix factorization, comprising:
receiving a rating matrix R; and
selecting a first value for variable p and a second value for variable q;
calculating a matrix X in a matrix factorization of R, wherein the calculating the matrix X is based on a matrix Θ^{T}, wherein R≈X·Θ^{T}, and wherein the calculating the matrix X comprises:
partitioning Θ^{T} by columns into p partitions of Θ^{T};
partitioning X by rows into q partitions of X;
partitioning R by rows and columns into p*q partitions of R;
copying to each accelerator, of a plurality of accelerators, a corresponding partition of Θ^{T};
copying to each accelerator, of the plurality of accelerators, a partition of R corresponding to the accelerator and corresponding to a current partition of X;
calculating, by the plurality of accelerators, a plurality of partial solutions for the current partition of X; and
aggregating the plurality of partial solutions for the current partition of X into a solution for the current partition of X.

2. The computer-implemented method of claim 1, further comprising calculating the matrix Θ^{T} of the matrix factorization of the matrix R, wherein the calculating the matrix Θ^{T} is based on X, and wherein the calculating the matrix Θ^{T} comprises:
partitioning X^{T} by columns into p partitions of X^{T};
partitioning Θ by rows into q partitions of Θ;
partitioning R^{T} by rows and columns into p*q partitions of R^{T};
copying to each accelerator, of the plurality of accelerators, a corresponding partition of X^{T};
copying to each accelerator, of the plurality of accelerators, a partition of R^{T} corresponding to the accelerator and corresponding to a current partition of Θ;
calculating, by the plurality of accelerators, a plurality of partial solutions for the current partition of Θ; and
aggregating the plurality of partial solutions for the current partition of Θ into a solution for the current partition of Θ.

3. The computer-implemented method of claim 2, further comprising repeating the calculating the matrix X and the calculating the matrix Θ^{T} until a termination condition is met.

4. The computer-implemented method of claim 1, wherein the calculating the plurality of partial solutions for X is performed by parallel threads.

5. The computer-implemented method of claim 1, wherein the plurality of accelerators are graphics processing units.

6. The computer-implemented method of claim 1, wherein the selecting the first value for the variable p and the second value for the variable q is based on a memory capacity of the plurality of accelerators.

7. The computer-implemented method of claim 6, wherein the selecting the first value for the variable p and the second value for the variable q comprises selecting the first and second values such that
$$\frac{m \times f}{q} + \frac{n \times f}{p} + \vert {R}^{( ij )} \vert + \frac{m}{q} \times {f}^{2} + \frac{m}{q} \times f + ε < C ,$$
wherein X is an m-by-f matrix, Θ^{T} is an f-by-n matrix, R^{(ij)} is a size of a partition of R, and ε is an additional allotted space.

8. The computer-implemented method of claim 7, wherein:
the first value for p is selected such that
$$\frac{n \times f}{p} \approx \frac{C}{2} ;$$
the second value for q is selected to be the smallest value such that
$$\frac{m \times f}{q} + \frac{n \times f}{p} + \vert {R}^{( ij )} \vert + \frac{m}{q} \times {f}^{2} + \frac{m}{q} \times f + ε < C ;$$
and
the first value for the variable p and the second value for the variable q are based on at least one of cost constraints and resource availability.

9. The method of claim 1, further comprising determining one or more recommendations of items to users based on X and Θ^{T}.
